(19) United States
(12) Patent Application Publication
(10) Pub. No.: US 2026/0141881 A1
(43) Pub. Date: May 21, 2026

(54) BASS DRUM BEATER WITH INTERCHANGEABLE STRIKING SURFACE USING HOOK AND LOOP AS A FASTENER

(71) Applicant: Howard Fleetwood Wilson, II, Buffalo, NY (US)

(72) Inventor: Howard Fleetwood Wilson, II, Buffalo, NY (US)

(21) Appl. No.: 19/395,072

(22) Filed: Nov. 20, 2025

Related U.S. Application Data
(60) Provisional application No. 63/722,650, filed on Nov. 20, 2024.

(51) Int. Cl. G10D 13/11

(52) U.S. Cl. CPC G10D 13/11

(57) ABSTRACT

A bass drum beater assembly with interchangeable striking surfaces is disclosed. The assembly comprises a beater post configured for attachment to a bass drum pedal, a beater head mounted on the beater post with a striking face, and a fastening system enabling rapid striking surface changes without tools. A looped fastener disc is permanently affixed to the striking face of the beater head. Multiple interchangeable striking pads are provided, each comprising a pad body formed of a selected striking material (such as felt, leather, wood, or plastic) and a hooked fastener disc on its rear surface. The hook and loop fastening system allows the striking pads to be quickly attached to and removed from the beater head while the beater remains installed on the pedal. This enables drummers to change bass drum tonal characteristics in seconds without requiring beater removal or tools, eliminating the need to carry multiple complete beaters.

### CROSS-REFERENCE TO RELATED APPLICATION

This application claims the benefit of U.S. Provisional Ser. No. 63/722,650, filed Nov. 20, 2024, which is incorporated herein by reference in its entirety.

### FIELD OF THE INVENTION

The present invention relates generally to percussion instruments and, more particularly, to a bass drum beater having an interchangeable striking surface that can be quickly changed using a hook and loop fastening system.

### BACKGROUND OF THE INVENTION

Bass drum beaters are essential components of bass drum pedals used by drummers in live performances and studio recording sessions. The striking surface of a beater significantly affects the tone, attack, and overall sound character produced when the beater contacts the bass drum head. Different musical styles, songs, and recording situations often require different tonal qualities from the bass drum.

Traditionally, drummers have used beaters with different striking surfaces to achieve varied sounds. Common striking surface materials include felt, leather, wood, and various synthetic materials, each producing a distinct tonal characteristic. Felt beaters typically produce a softer, warmer tone with less attack, while wood or hard plastic beaters create a sharper, more defined sound with pronounced attack. Leather beaters fall somewhere in between, offering moderate attack with warmth.

However, existing bass drum beaters present significant practical challenges for musicians who need to change sounds during a performance or recording session. Current methods for changing the striking surface of a bass drum beater require one of the following approaches.

First, a drummer may carry multiple complete beaters, each with a different striking surface. When a sound change is desired, the drummer must stop playing, use a drum key (typically an Allen wrench or similar tool) to loosen the set screw that secures the beater post to the pedal mechanism, remove the entire beater, select a different beater with the desired striking surface, insert it into the pedal mechanism, and retighten the set screw with the drum key. This process is time-consuming, interrupts the flow of performance or recording, and requires the drummer to carry and organize multiple complete beaters.

Second, some drummers have attempted to modify existing beaters by wrapping materials around the striking surface or using tape to change the sound characteristics. However, these improvised solutions are generally unreliable, can come loose during playing, produce inconsistent results, and may damage the beater or drum head.

The need to change beaters frequently creates additional problems beyond mere inconvenience. The repeated removal and reinstallation of beaters can wear the connection point on the pedal mechanism, potentially causing the beater to become loose during play. The requirement to carry multiple complete beaters increases the amount of equipment a drummer must transport and store. Furthermore, the time required to change beaters can interrupt creative flow during recording sessions or cause delays during live performances.

Therefore, there exists a need in the art for a bass drum beater system that allows quick, secure, and reliable changing of striking surfaces without requiring removal of the beater from the pedal, without requiring tools, and without interrupting the playing experience. Such a system would benefit professional drummers, recording studio musicians, and amateur players alike by providing versatility, convenience, and reliability in a single, elegant solution.

### SUMMARY OF THE INVENTION

The present invention solves the aforementioned problems by providing a bass drum beater with a novel interchangeable striking surface system utilizing hook and loop fasteners. The invention enables drummers to quickly change striking surfaces without removing the beater from the pedal and without requiring any tools.

In one embodiment, the invention comprises a bass drum beater assembly including a beater post configured for attachment to a bass drum pedal mechanism, a beater head mounted on one end of the beater post and having a striking face, a first fastening element affixed to the striking face of the beater head, and a plurality of interchangeable striking pads, each striking pad having a second fastening element configured to releasably engage with the first fastening element. The first and second fastening elements comprise complementary portions of a hook and loop fastening system, whereby the striking pads can be quickly attached to and detached from the beater head.

In a preferred embodiment, the first fastening element comprises a looped fastener disc permanently affixed to the striking face of the beater head, and each interchangeable striking pad comprises a pad body made of a striking surface material and a hooked fastener disc affixed to a rear surface of the pad body. The hook and loop engagement provides sufficient holding force to maintain the striking pad securely in place during normal drumming use, while allowing easy removal and replacement by the user.

The interchangeable striking pads may be constructed from various materials including, but not limited to, felt, leather, wood, hard plastic, rubber, synthetic materials, and combinations thereof. Each material produces a distinct tonal characteristic when striking the bass drum head. The pads may be provided as a set with the beater, allowing the drummer to select the appropriate striking surface for any musical situation.

The beater head may be cylindrical, spherical, or any other suitable shape, and may be constructed from materials including, but not limited to, wood, plastic, or metal. The beater post extends from the beater head and includes a connection end configured for secure attachment to standard bass drum pedal mechanisms, typically featuring a flat surface with a recess or hole for receiving a set screw.

One significant advantage of the present invention is that changing striking surfaces requires only seconds and can be accomplished without any tools. The drummer simply grasps the current striking pad, pulls it away from the beater head to disengage the hook and loop fastener, selects a different pad with the desired striking characteristics, and presses it onto the looped fastener disc on the beater head until the hook and loop elements are fully engaged. This process can be completed in seconds, compared to minutes or more required to completely remove and replace a traditional beater.

Another advantage is that the invention eliminates the need to carry multiple complete beaters. Instead, the drummer carries one beater assembly and a compact set of lightweight striking pads. This significantly reduces the bulk and weight of equipment that must be transported and stored.

A further advantage is that the beater remains installed on the pedal throughout the pad changing process, eliminating wear and tear on the connection point between the beater post and pedal mechanism that would otherwise result from repeated removal and reinstallation.

Additionally, the hook and loop fastening system provides a secure connection that maintains the striking pad in proper position during vigorous playing, while still allowing for easy removal when desired. The distributed attachment force across the entire fastener disc prevents the pad from shifting or rotating during use.

These and other objects, features, and advantages of the present invention will become apparent from the following detailed description, the accompanying drawings, and the appended claims.

### BRIEF DESCRIPTION OF THE DRAWINGS

FIG. 1 is a perspective view of a bass drum pedal assembly with the inventive beater installed, showing the beater head, beater post, and striking pad in an operational configuration;

FIG. 2 is a side view of the beater showing the beater head with an interchangeable striking pad attached via hook and loop fasteners;

FIG. 3 is a front perspective exploded view of the invention, illustrating the beater head with looped fastener disc and a striking pad with hooked fastener disc separated to show the fastening system;

FIG. 4 is a rear perspective exploded view of the invention, providing an alternative view of the beater head, looped fastener disc, striking pad, and hooked fastener disc in an exploded configuration; and

FIG. 5 is a front view showing the beater with four exemplary striking pads of different materials, demonstrating the variety of interchangeable options available to the user.

### DETAILED DESCRIPTION OF THE INVENTION

Referring now to the drawings, wherein like reference numerals designate identical or corresponding parts throughout the several views, the present invention will be described in detail.

### Overall System Configuration

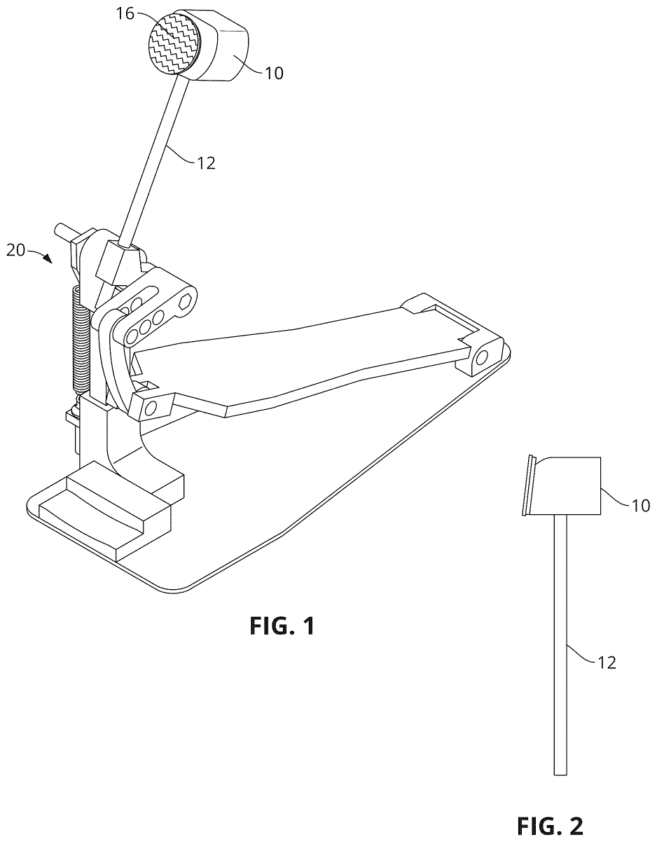

FIG. 1 illustrates a bass drum pedal assembly in a typical operational configuration with the inventive beater installed. The assembly includes a lower bass pedal assembly 20, which comprises the standard mechanical components of a bass drum pedal including a footboard, chain or strap drive mechanism, spring return system, and mounting hardware. The lower bass pedal assembly 20 is of conventional design and may be any commercially available bass drum pedal mechanism known in the art.

The inventive beater comprises a beater post 12 and a beater head 10. The beater post 12 is an elongated shaft, typically cylindrical in cross-section, having a first end connected to the lower bass pedal assembly 20 and a second end on which the beater head 10 is mounted. The connection between the beater post 12 and the lower bass pedal assembly 20 is accomplished through a standard connection mechanism, typically comprising a flattened or shaped end of the beater post that inserts into a receiving clamp on the pedal mechanism, where it is secured by a set screw. This connection allows the beater to rotate about its connection axis in response to actuation of the footboard, causing the beater head 10 to strike a bass drum head (not shown).

### Beater Head and Fastening System

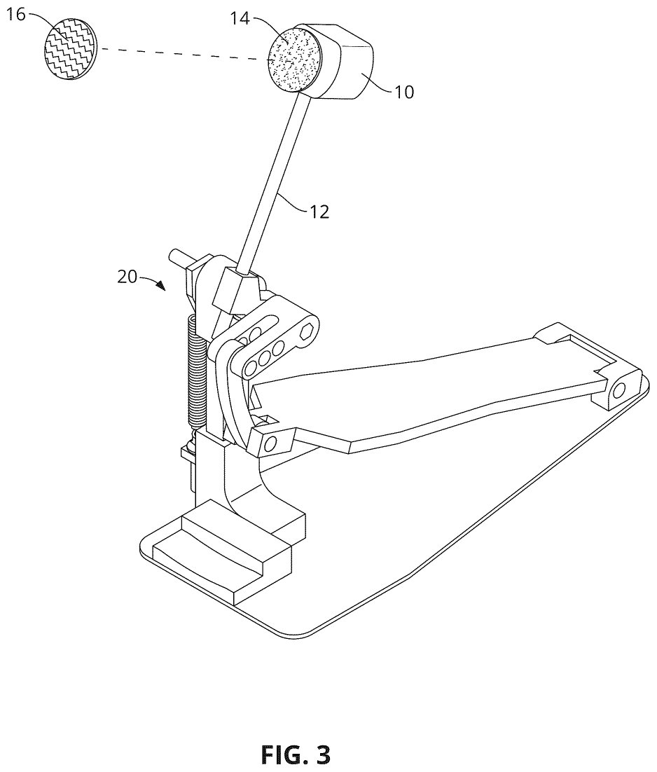

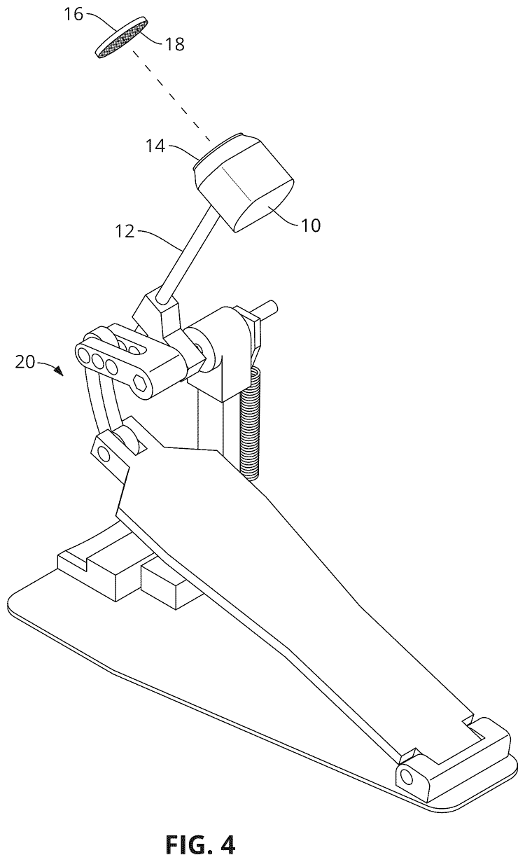

Referring now to FIGS. 2, 3, and 4, the beater head 10 is mounted on the upper end of the beater post 12. In the illustrated embodiment, the beater head 10 is generally cylindrical in shape with a flat or slightly convex striking face oriented perpendicular to the longitudinal axis of the beater post 12. However, the beater head 10 may alternatively be spherical, ellipsoidal, or any other suitable geometric shape. The beater head 10 may be constructed from various materials, including, but not limited to, wood, plastic, metal, or composite materials, and may be formed integrally with the beater post 12 or attached as a separate component.

Affixed to the striking face of the beater head 10 is a looped fastener disc 14. The looped fastener disc 14 comprises the “loop” portion of a hook and loop fastening system (commonly known by the trademark VELCRO®). The looped fastener disc 14 is permanently attached to the striking face of the beater head 10 using adhesive, mechanical fasteners, or integral molding during manufacturing. The looped fastener disc 14 is sized to cover substantially all of the striking face of the beater head 10 to provide maximum engagement area with the striking pads 16.

In the preferred embodiment, the looped fastener disc 14 is circular with a diameter approximately equal to or slightly less than the diameter of the striking face of the beater head 10. The loops of the fastener are oriented outward from the beater head, presenting a field of flexible loop elements ready to engage with complementary hook elements.

### Interchangeable Striking Pads

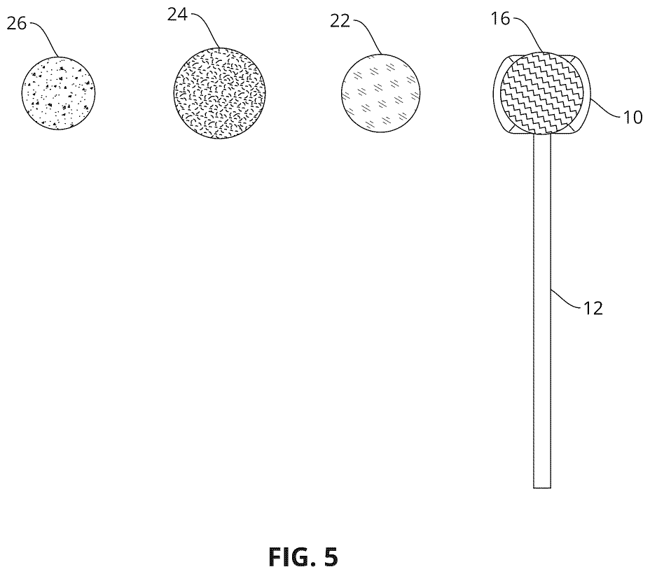

The invention includes a plurality of interchangeable striking pads that can be selectively attached to the beater head 10 via the looped fastener disc 14. FIG. 5 illustrates four exemplary striking pads (16, 22, 24 and 26), though any number of pads with various characteristics may be provided.

Each striking pad comprises a pad body constructed from a selected striking surface material, and a hooked fastener disc 18 affixed to the rear surface of the pad body. The pad body provides the actual striking surface that contacts the bass drum head during use, and the material of the pad body determines the tonal characteristics produced.

The first exemplary striking pad 16, best shown in FIGS. 2, 3, 4, and 5, comprises a pad body made of a first material (such as felt) with a hooked fastener disc 18 on its rear surface. The hooked fastener disc 18 comprises the “hook” portion of the hook and loop fastening system, featuring a field of small hook-shaped elements that engage with the loops of the looped fastener disc 14 on the beater head 10.

The second exemplary striking pad 22 (FIG. 5) may be constructed from a second material (such as leather), providing a different tonal characteristic than the first exemplary striking pad 16. The third exemplary striking pad 24 (FIG. 5) may be constructed from a denser felt or wool material, by way of example. The fourth exemplary striking pad 26 (FIG. 5) may be constructed from wood, hard plastic, or another hard material (by way of example) for maximum attack and definition. Each of these striking pads includes its own hooked fastener disc 18 affixed to the rear surface, configured identically to engage with the looped fastener disc 14 on the beater head 10.

The striking pads are generally circular in shape with a diameter substantially equal to the diameter of the looped fastener disc 14, ensuring complete coverage of the fastener and optimal engagement force. However, the pads may be sized slightly larger or smaller than the looped fastener disc 14 depending on design preferences and the desired striking characteristics.

The thickness of each striking pad may vary depending on the material and desired sound characteristics. Typical thicknesses range from approximately 3 mm to 20 mm, though pads outside this range are within the scope of the invention. The pad bodies may be formed from homogeneous materials or may comprise layered constructions combining different materials to achieve specific tonal properties.

### Operation and Use

The operation of the invention is straightforward and intuitive. Initially, the beater assembly is installed on the lower bass pedal assembly 20 by inserting the connection end of the beater post 12 into the pedal mechanism and securing it with the set screw, as is conventional in the art. The drummer selects an initial striking pad (for example, the first exemplary striking pad 16) and attaches it to the beater head 10 by aligning the hooked fastener disc 18 on the rear of the pad with the looped fastener disc 14 on the beater head, then pressing firmly to engage the hook and loop elements. The engagement is immediate and secure and can be confirmed by a slight audible “scratching” sound and tactile resistance.

During use, the drummer operates the bass drum pedal in the normal manner by pressing the footboard with their foot. This motion causes the beater post 12 to rotate about its connection point, swinging the beater head 10 forward until the striking pad contacts the bass drum head. The hook and loop connection maintains the striking pad firmly in position throughout this impact, even during aggressive playing styles. The secure engagement prevents the pad from shifting, rotating, or detaching during normal use.

When the drummer desires to change the striking characteristics of the bass drum, they simply reach forward, grasp the edge of the current striking pad, and pull it away from the beater head 10. The hook and loop fastener releases with moderate pulling force, allowing the pad to separate cleanly from the beater head. The drummer then selects a different striking pad with the desired material characteristics, aligns it with the looped fastener disc 14 on the beater head 10, and presses firmly to engage the fasteners. The entire pad-changing process typically requires only 2-5 seconds and can be accomplished without removing the beater from the pedal and without any tools.

This rapid changeability is particularly advantageous in several scenarios:
Live Performance: A drummer can change striking pads between songs or even during brief pauses within a song, allowing precise control over the bass drum tone throughout a performance. This eliminates the need to stop, remove the entire beater, locate a different beater, reinstall it, and resume playing—a process that would be impractical during most live performances.
Studio Recording: During recording sessions, producers and artists often experiment with different bass drum sounds for different sections of a song or different songs on an album. The present invention allows immediate sound changes without interrupting the creative flow or requiring the engineer to pause recording while the drummer changes equipment.
Practice and Education: Students learning to play drums can easily experiment with different striking surfaces to understand how material choice affects tone, developing their musical ear and expanding their knowledge of drum sound production.
Equipment Transport: Instead of carrying 4-6 complete beaters (each comprising a post, head, and integrated striking surface), the drummer carries one beater assembly and a small pouch containing multiple lightweight striking pads. This significantly reduces equipment bulk and weight.

### Variations and Alternatives

While the preferred embodiment utilizes a looped fastener disc 14 on the beater head 10 and hooked fastener discs 18 on the striking pads, the orientation of the fastener elements could be reversed. That is, a hooked fastener disc could be affixed to the beater head, and each striking pad could include a looped fastener disc. This alternative configuration would function identically, though the preferred embodiment (loops on the beater head) may be advantageous because the loops are generally more durable when repeatedly engaged and disengaged.

The shape of the beater head 10 may vary from the cylindrical form illustrated. For example, the beater head could be spherical, in which case the striking face would be a circular region on the sphere, and the looped fastener disc 14 would conform to this curved surface. Alternatively, the beater head could be conical, ellipsoidal, or irregularly shaped, with the looped fastener disc positioned on whatever surface is intended to strike the drum head.

The size of the beater head 10 and fastener discs may be varied to suit different applications. Larger beater heads with correspondingly larger fastener discs and striking pads may be preferred for bass drums with large diameter heads (24″ or larger), while smaller configurations may be suitable for compact drum kits or specialized applications.

The striking pads may incorporate additional features beyond the basic pad body and hooked fastener disc. For example, a striking pad could include a rim or reinforced edge to increase durability. Pads could be constructed with dual-layer designs, featuring a hard inner core with a softer outer layer, to achieve specific tonal combinations. Pads could include visual markings, color coding, or labeling to help the drummer quickly identify different materials.

In some embodiments, the hooked and looped fastener elements could be arranged in patterns rather than covering the entire disc, provided sufficient engagement force is maintained. For example, concentric rings of fastener material separated by gaps, or radial segments, could be used to reduce weight or material cost while maintaining adequate holding strength.

The attachment of the looped fastener disc 14 to the beater head 10 may be accomplished by various means. Industrial-strength adhesive is preferred for most applications, providing permanent bonding without adding significant thickness. Alternatively, mechanical fasteners such as small screws or rivets could be used, or the looped fastener material could be over-molded onto the beater head during manufacturing of plastic beater heads.

### Advantages Over Prior Art

The present invention provides numerous advantages over existing bass drum beater systems:
Speed of Change: Striking surfaces can be changed without tools, substantially reducing the time required to remove and replace entire beaters using a drum key.
No Pedal Disconnection Required: The beater remains installed on the pedal throughout the changing process, eliminating wear on the connection point.
Reduced Equipment Bulk: Drummers carry one beater assembly plus lightweight pads instead of multiple complete beaters, reducing transported equipment weight and volume significantly.
Secure Attachment: The distributed engagement of hook and loop fasteners provides reliable retention during aggressive playing while allowing easy removal when desired.
Cost Effective: Purchasing one beater assembly with multiple pads is significantly less expensive than purchasing multiple complete beaters.
Simplicity: No complex mechanisms, springs, clamps, or moving parts are required. The system is inherently reliable with no components to wear out or break.
Compatibility: The invention can be installed on any standard bass drum pedal without modification to the pedal mechanism.
Customization Potential: Users can create custom striking pads from any suitable material, opening possibilities for experimentation and personalization.

While the foregoing written description enables one of ordinary skill to make and use what is presently considered to be the best mode thereof, those of ordinary skill will understand and appreciate the existence of variations, combinations, and equivalents of the specific embodiments, methods, and examples herein. The invention should therefore not be limited by the above-described embodiments, methods, and examples, but by all embodiments and methods within the scope and spirit of the invention.

The detailed description provided above illustrates the preferred embodiment of the invention and provides sufficient enabling disclosure to allow one skilled in the art to practice the invention. However, it will be understood that various modifications may be made without departing from the spirit and scope of the invention as defined in the following claims.

What is claimed is:

1. A bass drum beater assembly comprising:
a beater post having a first end configured for attachment to a bass drum pedal and a second end;
a beater head mounted on said second end of said beater post, said beater head having a striking face;
a first fastening element affixed to said striking face of said beater head, said first fastening element comprising one of a hooked fastener or a looped fastener; and
at least one interchangeable striking pad comprising:
a pad body formed of a striking material; and
a second fastening element affixed to a rear surface of said pad body, said second fastening element comprising the complementary one of said hooked fastener or said looped fastener;
wherein said second fastening element is configured to releasably engage with said first fastening element to removably secure said striking pad to said beater head.

2. The bass drum beater assembly of claim 1, wherein said first fastening element comprises a looped fastener disc and said second fastening element comprises a hooked fastener disc.

3. The bass drum beater assembly of claim 2, wherein said looped fastener disc is permanently affixed to said striking face of said beater head.

4. The bass drum beater assembly of claim 1, wherein said beater head is cylindrical.

5. The bass drum beater assembly of claim 1, wherein said beater head is spherical.

6. The bass drum beater assembly of claim 1, wherein said pad body is formed from a material selected from the group consisting of felt, leather, wood, hard plastic, rubber, wool, and synthetic materials.

7. The bass drum beater assembly of claim 1, further comprising a plurality of interchangeable striking pads, each striking pad having a pad body formed of a different striking material to produce different tonal characteristics.

8. The bass drum beater assembly of claim 7, wherein said plurality of interchangeable striking pads comprises at least one pad formed of felt, at least one pad formed of leather, and at least one pad formed of wood.

9. The bass drum beater assembly of claim 1, wherein said first fastening element and said second fastening element are circular discs having substantially equal diameters.

10. The bass drum beater assembly of claim 1, wherein said striking face of said beater head is substantially planar and oriented perpendicular to a longitudinal axis of said beater post.

11. A kit for modifying bass drum beater tone comprising:
a beater assembly comprising:
a beater post configured for attachment to a bass drum pedal; and
a beater head mounted on said beater post and having a looped fastener disc affixed to a striking face thereof; and
a plurality of interchangeable striking pads, each said striking pad comprising:
a pad body formed of a striking material; and
a hooked fastener disc affixed to a rear surface of said pad body, said hooked fastener disc configured to releasably engage with said looped fastener disc on said beater head;
wherein said plurality of striking pads comprises at least two pads having pad bodies formed of different materials to produce different tonal characteristics when striking a bass drum head.

12. The kit of claim 11, wherein said plurality of interchangeable striking pads comprises at least three pads having pad bodies formed of different materials selected from the group consisting of felt, leather, wood, and hard plastic.

13. The kit of claim 11, wherein said plurality of interchangeable striking pads comprises at least four pads.

14. The kit of claim 11, wherein each said striking pad in said plurality has a substantially circular shape with a diameter substantially equal to a diameter of said looped fastener disc.

15. The kit of claim 11, wherein said beater post comprises a flattened connection end configured for insertion into a clamp mechanism of a bass drum pedal.

16. The kit of claim 11, wherein said looped fastener disc covers substantially all of said striking face of said beater head.
